(19) United States
(12) Patent Application Publication
(10) Pub. No.: US 2026/0227657 A1
(43) Pub. Date: Aug. 6, 2026

(54) INFRARED ILLUMINATION FOR A LIQUID CRYSTAL DISPLAY

(71) Applicant: Ford Global Technologies, LLC, Dearborn, MI (US)

(72) Inventors: Mark Larry, Macomb, MI (US); Biaohe Guo, Northville, MI (US); Benjamin Lewis, Livonia, MI (US)

(73) Assignee: Ford Global Technologies, LLC, Dearborn, MI (US)

(21) Appl. No.: 19/042,035

(22) Filed: Jan. 31, 2025

(51) Int. Cl. G02F 1/13357; B60K 35/22; G02F 1/1333; G02F 1/1335

(52) U.S. Cl. CPC G02F 1/133603; B60K 35/22; G02F 1/133524; B60K 2360/21; G02F 1/133331; G02F 1/13362

(57) ABSTRACT

A computer that includes a processor and a memory, the memory including instructions executable by the processor to acquire an image from a camera included in light emitting diode (LED) backlit liquid crystal display (LCD) device, wherein the camera is located adjacent to an active display area of the LCD device through a portion of a front panel of the LCD device in which one or more polarizing layers of the front panel are absent to permit light to reach the camera. The scene can be illuminated beyond the front panel of the LCD device with IR light emitted by IR LEDs attached to a backlight substrate and directed to the front panel of the LCD device by IR lightguides.

### BACKGROUND

Systems that move, are carried, and/or that have mobile components, including vehicles, robots, drones, cell phones etc., can be operated by acquiring and processing sensor data, including data regarding system status and data regarding an environment around the system. Computing devices included in a vehicle, for example, can format and output the data to display devices for vehicle occupants to view and interact with via touch screen technology included in the display device.

### BRIEF DESCRIPTION OF THE DRAWINGS

FIG. 1 is a block diagram of an example vehicle system.

FIG. 2 is a diagram of an example vehicle display.

FIG. 3 is a diagram of an example liquid crystal display (LCD) front panel.

FIG. 4 is a diagram of an example LCD device.

FIG. 5 is a diagram of an example LCD device with integrated camera.

FIG. 6 is a diagram of integrated cameras with LED lights.

FIG. 7 is a diagram of an LCD device with integrated camera and LED lights.

FIG. 8 is a diagram of an LED lightguide.

FIG. 9 is a flowchart diagram of an example process to control an integrated camera and LED lights.

### DETAILED DESCRIPTION

Vehicles will be used herein as a non-limiting example of devices that can include display devices. Liquid crystal display (LCD) devices are examples of display devices that can be included in vehicles, where they may be used to display data generated by or about the vehicle and components thereof. When combined with touch screen technology, LCD devices can acquire user input to control vehicle components. LCD devices can be controlled by display controllers included in computing devices included in a vehicle. The computing devices acquire data from vehicle sensors, memory included in the computing device, and network interfaces that can acquire data from sources such server computers and/or the Internet. Computing devices included in the vehicle can acquire and process data and format it for display on an LCD device via a display controller. Data displayed on an LCD device includes text, depictions of gauges and instruments, depictions of controls such as buttons, maps, and/or images that depict an environment around a vehicle.

An LCD device can display a wide variety of data including, but not limited to, vehicle control screens that control vehicle systems such a climate control and vehicle propulsion, vehicle status data such as vehicle speed, energy usage, and vehicle service notices, data regarding the environment around the vehicle such as traffic and navigation maps, entertainment data such as cable TV, movies, video games, and the Internet via web browsers, and cellular telephone data such as text messages. Vehicle data displays can display data generated by vehicle systems and vehicle computing devices and most data available on cable TV, the Internet, home or business computers and video game systems.

LCD devices can include touch screen technology that permits a user to interact with the LCD device by touching a portion of the screen. The location of the portion of the LCD device being touched can be transmitted to a computing device in the vehicle by the touch screen technology. The computing device can determine the location on the LCD device in relation to the data being displayed to determine which displayed function is being accessed by the user. For example, icons indicating vehicle component controls can be displayed on an LCD device and the component can be controlled by touching portions of the LCD device that correspond to the indicated control function.

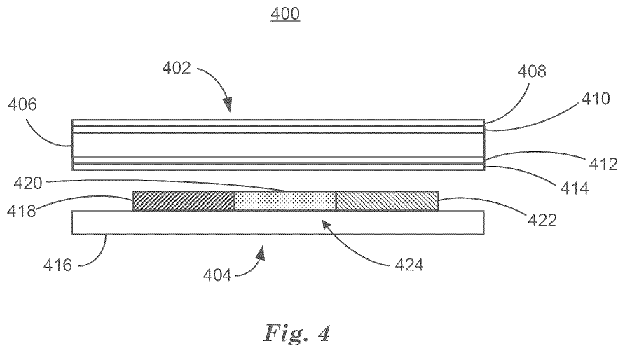

LCD devices can include LED backlights to illuminate the LCD device. LED backlights can include an array of LEDs on a substrate behind the LCD front panel. Direct-lit (also known as full-array local dimming or FALD) can save power over other types of backlights such as edge lit backlights by permitting the backlight to be modulated to match the light to be emitted from the LCD front panel. LCD devices with LED backlights can employ red, green, and blue (RGB) LEDs integrated into a single LED package to form a white LED. In other examples a blue LED with a yellow phosphor coating or quantum dot coating can be combined to form a white LED. A color filter as described below in relation to FIG. 4, below supplies red, green, and blue (RGB) sub-pixel filters where each color is energized by diffused white LEDs. The RGB sub-pixel filters are combined into a single color pixel by light emitted by the LCD front panel.

Cameras such as video cameras can be included in vehicle interiors to monitor users, provide input for biometric identification, and provide communications for applications such as video conferencing. Cameras can be located in the center of the vehicle dashboard near the display device, in what is referred to as the center stack display position. Locating a camera in the center stack display position and equipping the camera with wide-angle lenses permits a single camera to acquire data over the entire front seat portion of the vehicle interior. IR cameras can acquire images from scenes illuminated with infrared (IR) light to permit the camera to operate in widely varying ambient light conditions without disturbing vehicle users. RGB-IR cameras can acquire images from scenes illuminated with both ambient light and with IR light sources. Both IR cameras and RGB-IR cameras can include lenses having wide-angle fields of view to match wide angle illumination patterns of IR lights. Techniques described herein can acquire image data using either IR cameras or RGB-IR cameras and “camera” will be used herein to refer to either an IR camera or an RGB-IR camera.

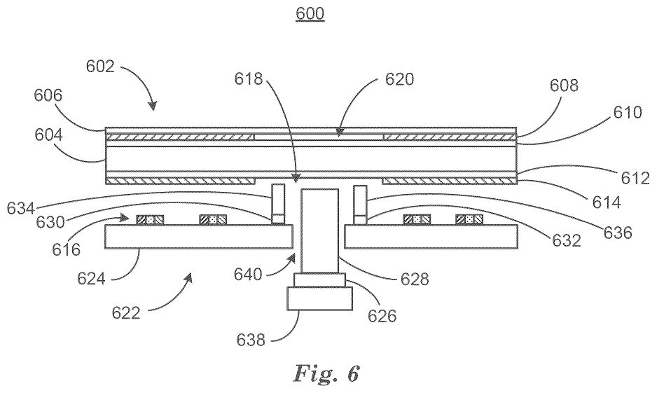

Cameras and IR light sources can be integrated into an LCD device in different ways. A camera and IR light sources can be integrated into the active area of the LCD device. Integrating the camera and IR light source into the active area of an LCD device can require that portions of the active display area are inactivated to permit light to be emitted by the IR light sources and received by the camera as discussed below in relation to FIG. 6. This can result in a blank portion of in the active display area of the LCD device. Techniques described herein for using lightguides for the IR light sources can minimize the blank portion due to the camera and IR light sources.

The blank portion of the active display area can be inset along one edge of the active display area of an LCD device to form a “notch.” The notch is an area along one edge of the active display that adds a camera and lights by removing a portion of the active display area of the LCD device. Techniques described herein can minimize the size of the notch using lightguides for the IR light sources to minimize the blank portion of the active display area of the LCD device. A third example uses the minimal size of the camera and IR light sources due to the IR lightguides to integrate the camera and IR light sources into the border portion of the LCD device and avoiding a blank portion of the active area of the LCD device altogether.

Techniques described herein for vehicles that include a camera (or cameras) and an LCD device can integrate a camera and IR lights into an LCD device to maximize usable display area for an LCD device while minimizing LCD device border areas. Border areas are portions of the LCD device that surrounds the active display area but does not include active data display areas. Border areas can also include portions between active display areas in LCD devices that include multiple active display areas. By integrating the camera and IR light into the LED backlight structure of the LCD device and providing the camera with a wide-angle lens and providing the IR lights with wide-angle lightguides, the camera can acquire data from the entire front-seat portion of the vehicle while minimizing the size of the border surrounding the active LCD device.

Disclosed herein is a method including acquiring an image from a camera included in light emitting diode (LED) backlit liquid crystal display (LCD) device, wherein the camera is located adjacent to an active display area of the LCD device through a portion of a front panel of the LCD device in which one or more polarizing layers of the front panel are absent to permit light to reach the camera. A scene can be illuminated beyond the front panel of the LCD device with IR light emitted by IR LEDs attached to a backlight substrate and directed to the front panel of the LCD device by IR lightguides. The camera can be mounted on a substrate located behind the backlight substrate.

The IR LEDs can be mounted on the backlight substrate that includes the LEDs. The IR lightguides can connect the IR LEDs to the front panel of the LCD device. The front panel of the LCD device can include a glass cover, an LCD panel and the one or more polarizer layers. The camera can include a wide-angle lens. The IR lightguides can emit IR light which illuminate the scene included in a field of view of the camera with the wide-angle lens. The IR lightguides can be arranged in a circle or a rectangle adjacent to the camera. The LCD device can be included in a vehicle. The LCD device can be included in a dashboard included in the vehicle. The vehicle can be operated based on the image. The front panel of the LCD device can include an RGB filter. The RGB filter of the front panel can be absent to permit light to reach the camera. The IR lightguides can include output lenses.

Further disclosed is a computer readable medium, storing program instructions for executing some or all of the above method steps. Further disclosed is a computer programmed for executing some or all of the above method steps, including a computer apparatus, programmed to acquire an image from a camera included in a light emitting diode (LED) backlit liquid crystal display (LCD) device, wherein the camera is located adjacent to an active display area of the LCD device through a portion of a front panel of the LCD device in which one or more polarizing layers of the front panel are absent to permit light to reach the camera. A scene can be illuminated beyond the front panel of the LCD device with IR light emitted by IR LEDs attached to a backlight substrate and directed to the front panel of the LCD device by IR lightguides. The camera can be mounted on a substrate located behind the backlight substrate.

The instructions can include further instructions wherein the IR LEDs can be mounted on the backlight substrate that includes the LEDs. The IR lightguides can connect the IR LEDs to the front panel of the LCD device. The front panel of the LCD device can include a glass cover, an LCD panel and the one or more polarizer layers. The camera can include a wide-angle lens. The IR lightguides can emit IR light which illuminate the scene included in a field of view of the camera with the wide-angle lens. The IR lightguides can be arranged in a circle or a rectangle adjacent to the camera. The LCD device can be included in a vehicle. The LCD device can be included in a dashboard included in the vehicle. The vehicle can be operated based on the image. The front panel of the LCD device can include an RGB filter. The RGB filter of the front panel can be absent to permit light to reach the camera. The IR lightguides can include output lenses.

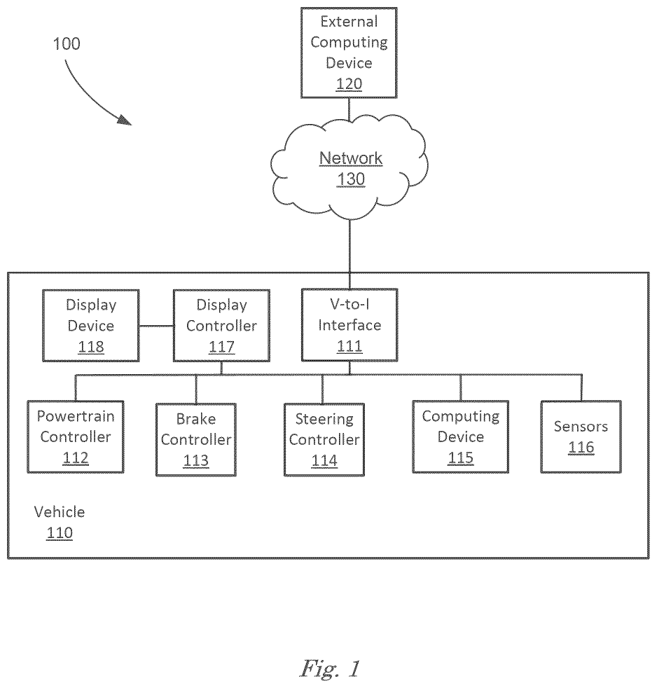

FIG. 1 is a diagram of vehicle system 100. Vehicle system 100 includes a vehicle 110. The vehicle 110 is generally a land-based vehicle 110 capable of autonomous and semi-autonomous operation and having three or more wheels (i.e., a passenger car, light truck, etc.). Vehicle 110 includes one or more sensors 116, the V2I interface 111, a computing device 115, one or more controllers 112, 113, 114, 117 and a display device 118. One or more vehicle computing devices 115 can receive data regarding the operation of the vehicle 110 from sensors 116.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and exterior lights, etc., as well as to determine whether and when the computing device 115, as opposed to a human operator, is to control such operations. The computing device 115 can also control the temporal alignment of lighting to sensor acquisition to account for the color effects of vehicle lights or external lights.

The computing device 115 may include or be communicatively coupled to (i.e., via a vehicle communications bus as described further below) more than one computing devices (i.e., controllers or the like included in the vehicle 110 for monitoring and controlling various vehicle components), (i.e., a propulsion controller 112, a brake controller 113, a steering controller 114, display controller 117 etc.). The computing device 115 is generally arranged for communications on a vehicle communication network, (i.e., including a bus in the vehicle 110 such as a controller area network (CAN) or the like); the vehicle 110 network can additionally or alternatively include wired or wireless communication mechanisms such as are known, (i.e., Ethernet or other communication protocols).

Via the vehicle network, the computing device 115 may transmit messages to various devices in vehicle 110 and receive messages from the various devices, (i.e., controllers, actuators, sensors, etc., including sensors 116). Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network. In addition, the computing device 115 may be configured for communicating through a vehicle-to-infrastructure (V2I) interface 111 with an external computing device 120, (i.e., a cloud server), via a network 130, which, as described below, includes hardware, firmware, and software that permits computing device 115 to communicate with an external computing device 120, which can include the Internet via a network 130 such as wireless Internet (e.g., WI-FI®) or cellular networks. V2X interface 111 may accordingly include processors, memory, transceivers, etc., configured to utilize various wired and wireless networking technologies, (i.e., cellular, BLUETOOTH®, Bluetooth Low Energy (BLE), Ultra-Wideband (UWB), Peer-to-Peer communication, UWB based Radar, IEEE 802.11, and other wired and wireless packet networks or technologies). The computing device 115 also includes nonvolatile memory such as is known.

As already mentioned, generally included in instructions stored in the memory and executable by the processor of the computing device 115 is programming for operating one or more vehicle 110 components, (i.e., braking, steering, propulsion, etc.), without intervention of a human operator. Using data received in the computing device 115, (i.e., the sensor data from the sensors 116, an external computing device 120, etc.), the computing device 115 may make various determinations and control various vehicle 110 components and operations. For example, the computing device 115 may include programming to regulate or control vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and control a specific vehicle subsystem. Examples include a propulsion controller 112, a brake controller 113, a steering controller 114 and a display controller 117. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from another ECU included in vehicle 110 (e.g., the computing device 115, to operate the brakes of the vehicle 110).

The one or more controllers 112, 113, 114, 117 for the vehicle 110 may include known electronic control units (ECUs) or the like including, as non-limiting examples, one or more propulsion controllers 112, one or more brake controllers 113, one or more steering controllers 114 and one or more display controllers. Each of the controllers 112, 113, 114, 117 may include respective processors and memories and one or more actuators. The controllers 112, 113, 114, 117 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. Sensors 116 may collect data related to the vehicle 110 and the environment in which the vehicle 110 is operating. By way of example, and not limitation, sensors 116 may include, (i.e., altimeters, cameras, LIDAR, radar, ultrasonic sensors, infrared sensors, pressure sensors, accelerometers, gyroscopes, temperature sensors, hall sensors, optical sensors, voltage sensors, current sensors, mechanical sensors such as switches, etc.) The sensors 116 may be used to sense the environment in which the vehicle 110 is operating, (i.e., sensors 116 can detect phenomena such as weather conditions (precipitation, external ambient temperature, etc.)), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114, 117 in the vehicle 110, connectivity between components, and accurate and timely performance of components of the vehicle 110.

Display device 118 displays two-dimensional visual data to occupants of a vehicle. Display device 118 can display visual data in monochrome or color and the visual data can be updated at a frame rate, which can be 60 frames per second, for example. Displayed visual data can be a static image, where the majority of the two-dimensional area does not change from frame to frame, or a dynamic image, where the majority of the two-dimensional area changes from frame to frame. Visual data to be displayed on display device 118 can be generated by display controller 117. Display controller 117 is a computing device such as an ECU or the like that can receive data to be displayed on display device 118 in a visual format from computing device 115, other vehicle ECUs, or from an external computing device 120 via network 130.

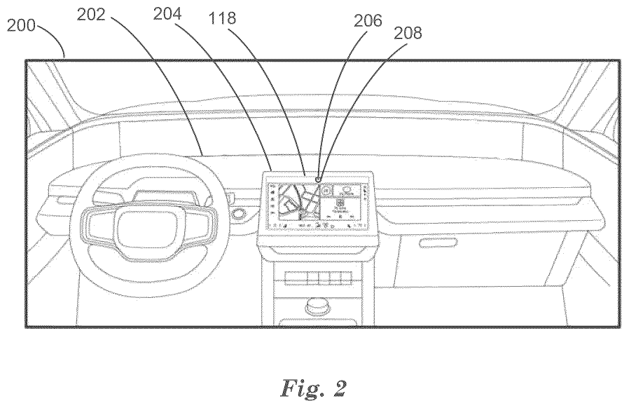

FIG. 2 is a diagram of an image 200 of a portion of a vehicle interior including a dashboard 202. Included in the dashboard 202 is the center stack display position 204. The center stack display position 204 can include a display device 118. Display device 118 can be controlled by computing device 115 via display controller 117 to display status data regarding vehicle status such as speed and remaining energy, vehicle environmental controls such as heating and cooling, infotainment controls including audio and video data, navigation data such as maps and directions, and connectivity data such as web pages and phone calls, etc.

Display device 118 can also be equipped with touch screen technology to permit a user to enter commands by touching the display device 118. For example, display device can be programmed by computing device 115 to display buttons, dials, or other types of controls. By touching the displayed controls, a user can enter commands that can be received by computing device 115. Commands entered via a touch screen included in a display device 118 can be used by computing device 115 to control vehicle components such as environmental, infotainment, environmental, or connectivity.

A display device can be used to display a variety of types of data in varying ambient light conditions. The ambient light conditions can range from bright sunlight to dark night. LCD device 118 can be equipped with a camera 206 and IR lights 208 in the border portion of display device 118. Integrating a camera 206 and IR lights 208 in the border portion of display device 118 can provide maximum wide-angle coverage of the vehicle interior while minimizing the portion of the center stack display position 204 occupied by display device, camera 206 and IR lights 208.

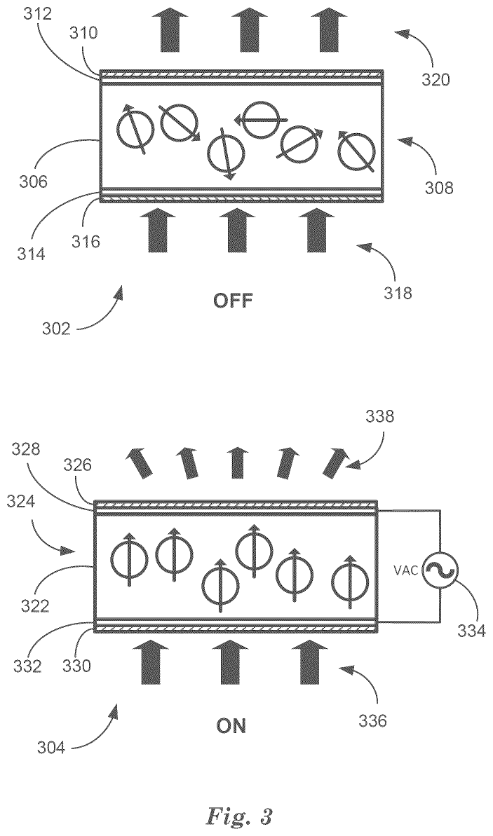

FIG. 3 is a diagram of two cross sectional views of portions of liquid crystal display (LCD) panels 302, 304 that could be included in a display device 118. An LCD panel 302, 304 can be included in a display device 118. LCD panels 302, 304 can receive data from a computing device 115 via a display controller 117 to cause portions of the LCD panel 302, 304 to be opaque or transparent in a pattern that causes the LCD panel 302, 304 to display the received data by transmitting or blocking input light 318, 336. The input light 318, 336 can be supplied by an LED backlight as described below in relation to FIGS. 4-6.

LCD panel 302 is shown as a cross-sectional view of a twisted nematic liquid crystal display in an ON state. LCD panel 304 is shown as a cross-sectional view of a twisted nematic liquid crystal display in an OFF state. A liquid crystal display includes two paired polarizer layers 310, 316 and 326, 330. The paired polarizer layers 310, 316 and 326, 330 are arranged to be at 90-degree polarization angles, which causes the LCD panel 302 to be in the ON state and transmit light, or 0 degrees, which causes the LCD panel 304 to inhibit the transmission of light. The interior space 306, 322 of the LCDs can be filled with liquid crystal molecules 308, 324, which can form a material that rotationally polarizes light such as a twisted nematic liquid crystal molecule. LCD panels 302, 304 do not emit light directly, but transmit varying degrees of input light 318, 336, depending upon voltage 334 applied to thin film transistor (TFT) electrodes 314, 332, generating output light 320, 338 that passes through RGB filter 312. The TFT electrodes 314, 332 can be applied to a glass substrate and can be made of a transparent, conductive material such as indium-tin oxide (ITO).

Assuming an ON state of the LCD panel 302, 90-degree polarization is provided when input light is applied, then in the OFF state, the liquid crystal molecules 308, 324 assume a helical pattern adjacent to the TFT electrodes 314. The helical pattern imparts a 90-degree polarization in light 318 being transmitted by LCD panel 302. The 90-degree polarization imparted to the light causes the input polarizer 316 to match the output polarizer 310, which permits a large percentage of the input light 318 to appear as output light 320. Applying a voltage 334 across the TFT electrodes 332 causes the liquid crystal molecules 324 to align with respective first ends towards one electrode 328 and their other ends towards the other electrode 332, which prevents the liquid crystal molecules from imparting a polarization to the input light 336 which then permits the crossed polarizer layers 326, 330 to block light, making the LCD panel 304 non-transmissive and reducing the light output 338 from the LCD panel 304. Varying voltage 334 can change the light output 320, 338 from bright (no voltage) to dark (maximum voltage) depending upon the voltage.

In addition to varying voltage 334 to determine light output 320, 338, light output 320, 338 can depend upon the light input 318, 336. A technique for supplying light input 318, 336 to an LCD panels 302, 304 is to apply a reflective layer of material beneath the lower polarizer 316, 330 to reflect light incident on the LCD panels 302, 304 from above. This technique has the advantage of utilizing no power or wiring but is dependent upon ambient lighting to make the LCD panels 302, 304 legible, for example, readable or viewable by a person. Backlighting is a technique for applying illumination to an LCD panels 302, 304 from beneath the lower polarizer 316, 330. Techniques for backlighting include edge lighting, which supplies light to a transparent layer of material from the lateral edges of the LCD panels 302, 304. This light can be supplied by LEDs or cold cathode fluorescent lamps, for example. These technologies supply uniform light to backlight the entire LCD panels 302, 304.

Techniques for zone lighting of LCD devices use LED backlighting and RGB filter 312 to enhance visibility of data displayed on an LCD device while permitting control of the intensity of the backlight illumination in zones which group adjacent LEDs. LED backlights are described in relation to FIG. 4, below. Controlling the intensity of the backlight illumination permits power saving by turning down the intensity of dim portions of the data displayed on the LCD device. Because the LCD device operates by blocking light emitted from the backlight, the backlight can be dimmed to save power consumed by the LEDs without changing the appearance of the display. By controlling the LED backlight in zones, zones that correspond to portions of the LCD panel 302, 304 that include data having small details can be controlled to ensure that the small details are visible in varying ambient light conditions. For example, if map data is displayed in ambient light conditions that include bright sunlight, data corresponding to roads in dark portions of the map data can be enhanced by increasing the energy controlling the illumination of LEDs in a zone corresponding to the dark portion of the map data.

FIG. 4 is a diagram of a cross-sectional view of a portion of a display device 118. Display device 118 includes an LCD panel 402 and an LED backlight 404. LCD front panel 402 includes liquid crystal 406, polarizer layers 408, 414, RGB filter 410 and TFT electrodes 412. As described above in relation to FIG. 3, LCD panel 402 modulates light emitted by LED backlight 404 to form a display on the LCD panel 402 based on data that energizes TFT electrodes 412 to block or transmit light emitted from LED backlight 404. TFT electrodes 412 are patterned, generally in a grid pattern that permits addressing the TFT electrodes 412 in an x, y pattern by a computing device 115 to display image data on display device 118.

LED backlight 404 includes white LEDs 418, 420, 422 as described above, referred to herein collectively as LEDs 424. LEDs 424 are attached to a backlight substrate 416 that supplies power controlled by computing device 115 to the LEDs 424. Light emitted by white LEDs 418, 420, 422 illuminate LCD panel 402 and is either blocked or transmitted through liquid crystal molecules 406 to RGB filter 410 which include red 426, green 428, and blue 430 sub-pixel filters depending upon whether the TFT electrodes 412 are energized by computing device 115. An array of LEDs 424 can be attached to backlight substrate 404 to form display device 118. Hundreds or thousands of LEDs 424 can be attached to backlight substrate 404 to form a backlight for display device 118, the LEDs 424 and can be divided into zones of adjacent LEDs 424.

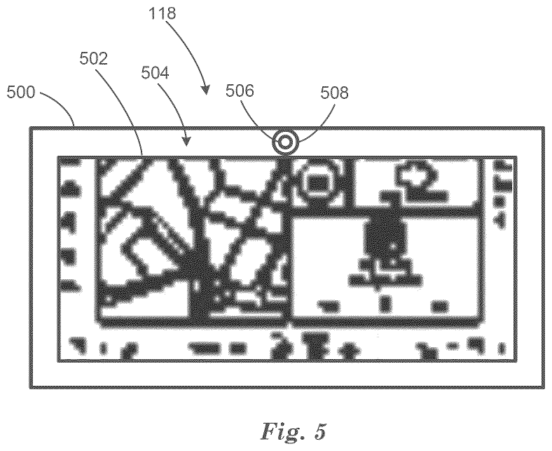

FIG. 5 is a diagram of a display device 118 that includes a camera 506 and IR lights 508 included in the border 504 portion of display device 118. Camera 506 and IR lights 508 can be integrated into the LED backlight 404 that illuminates the display device 118. Integrating the camera 506 and IR lights 508 into the LED backlight 404 permits the camera 506 and IR lights 508 to be at the minimum distance from the active display 502 portion of the display device 118 without interfering with the active display 502.

Combining the camera 506 and IR lights 508 in border 504 portion of display device 118 permits the camera 506 and IR lights 508 to be integrated into the LED backlight 404 which reduces the size of the display device 118 and camera 506 and IR lights 508 in the center stack display position 204. Combining the camera 506 and IR lights 508 in border 504 portion of with display device 118 also reduces a number of parts of an LCD display 118 with IR lights 508 and camera 506 by mounting the IR lights 508 on the LED backlight 404 which eliminates a separate circuit board and eliminates separate packaging components for the IR lights 508 and camera 506. In examples where the display device 118 is connected to computing device 115 via a CAN bus, combining the display device 118, camera 506, and IR lights 508 can permit the display device 118, camera 506, and IR lights 508 to be controlled with a single CAN bus interface. Techniques described herein for LED backlight 404, mounted camera 506, and IR lights 508 in the border 504 portion of a display device 118 can reduce display device 118 size, display device 118 component count, display device 118 packaging, and display device 118 interconnect complexity over designs which do not integrate cameras 506 and IR lights 508 in the border 504 portion of a display device 118.

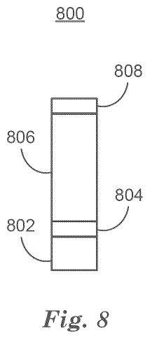

FIG. 6 is a diagram of a display device 118 including an LCD front panel 602 and an LED backlight 622. LCD front panel 602 includes liquid crystal 604, a glass cover 606, polarizer layers 608, 614, TFT electrodes 612, and RGB filter 610 as described above in relation to FIG. 4. LED backlight 622 includes a backlight substrate 624 that includes LEDs 616 as described above in relation to FIG. 4. Display device 118 also includes windows 618, 620, 642 formed in polarizer layers 608, 614 and RGB filter 610. Windows 618, 620 in polarizer layers permit IR light emitted from IR LEDs 630, 632 via lightguides 634, 636 to be transmitted through LCD front panel 602. Modifications to IR LEDs 630, 632 that permit wide-angle IR illumination are described in relation to FIG. 8, below. TFT electrodes 612 can be formed from materials such as Indium-Tin-Oxide (ITO) which transmits IR light without appreciable attenuation. Glass cover 606 also transmits IR light without appreciable attenuation.

IR LEDs 630, 632 can be attached to backlight substrate 624, which reduces packaging and connectivity complexity over examples which include a separate substrate for the IR LEDs 630, 632. Including IR LEDs 630, 632 in backlight substrate 624 can eliminate requirements for separate packaging and separate network and power connections for IR LEDs 630, 632. In some examples, camera 626 and wide-angle lens 628 can be mounted on backlight substrate 624. In examples where camera 626 and wide-angle lens 628 do not fit within the space between LCD front panel 602 and backlight substrate 624, a window 640 can be formed in the backlight substrate 624 and the camera 626 and wide-angle lens 628 can be mounted on a separate camera substrate 638. Camera substrate 638 can be electrically and logically connected to the LED backlight 624 to permit the same savings in packaging, network connections, and power connections as IR LEDs 630, 632.

Transmitting IR light from IR LEDs 630, 632 and receiving IR light by camera 626 via wide-angle lens 628 can require modifications to an LCD front panel 602 that interfere with the display function of the LCD front panel 602 (e.g., forming windows 618, 620, 642 in polarizer layers 608, 614 and RGB filter 610). If the IR LEDs 630, 632 and camera 626, along with wide-angle lightguides 634, 636 and wide-angle lens 628 are located in the active display 502 portion of display device 118, the appearance of the active display 502 portion of display device 118 will be compromised by a minimal amount because of the minimal area of the windows 618, 620, 642 in the polarizers 608, 614 and RGB filter 610. If the IR lightguides 634, 636 and camera 626 are mounted outside of the border 504 portion of the display device 118, the additional packaging can be facilitated by the addition of a “notch” in a bezel included in the center stack display position 204 of the dashboard 202. Both locating the IR lightguides 634, 636 and camera 626 in the active display 502 and locating the IR lightguides 634, 636 and camera 626 in a notch adjacent to the display device 118 consume less active display areas than cameras and lights that do not use IR lightguides 634, 636. Locating the IR LEDs 630, 632 and camera 626 in the border 504 within the LCD front panel 602 and adjacent to the active display 502 does not require any reduction in active display area and requires minimal border 504 width, providing a compact LCD device 118 and wide-angle coverage by the camera.

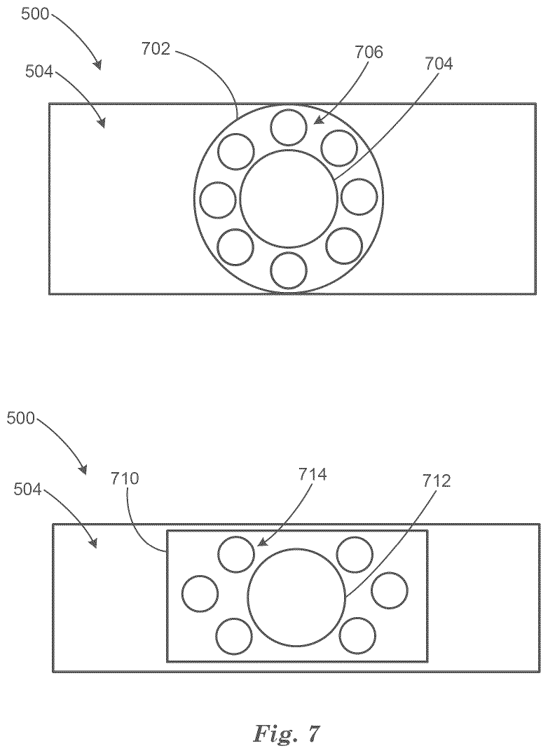

FIG. 7 is a diagram of top-down views of two example windows 702, 710 in two examples of border 504 portions of a display device 118. Circular window 702 includes a wide-angle camera lens 704 surrounded by IR lightguides 706 arranged in a circle around the wide-angle camera lens 704. Rectangular window 710 includes a wide-angle lens 712 with IR lightguides 714 arranged on either side of the wide-angle lens 712 in a rectangle. Circular window 702 provides more room for IR lightguides 706 and more even illumination while rectangular window 710 fits in a smaller border 504 portion while having somewhat less even illumination. Other arrangements of windows 702, 710 and IR lightguides 706, 714 are possible.

FIG. 8 is a diagram of an IR lightguide assembly 800 that includes an IR LED 802, an IR lightguide 806, optional LED lens 804, and optional output lens 808. As discussed above in relation to FIG. 6, IR LEDs 802 emit IR light which is transported to the LCD front panel 602 by an IR lightguide 806. An IR lightguide 806 is an optical device that can be an optical fiber, a bundle of optical fibers, or can be made of cast or machined acrylic plastic, among other materials. The function of the IR lightguide 806 is to receive optical radiation from an IR LED 802 and, as long as the light rays maintain an angle less than the critical angle with respect to the walls of the IR lightguide 806, will be contained within the IR lightguide 806 by total internal reflection until the reaching the end of the IR lightguide 806 proximate to the LCD front panel 602.

IR lightguide 806 can also optionally include LED lens 804 and output lens 808. LED lens 804 can be included in the IR LED 802 package. An IR LED 802 can include a lens because IR LED chips can emit light in a 180-degree hemisphere and adding an LED lens 804 can focus the light output from the IR LED 802 to enter the lightguide 806 with a vertical dispersion of less than the critical angle of the IR lightguide 806. Entering the lightguide 806 with a dispersion of less than the critical angle ensures that the majority of the IR light energy will be transmitted through the IR lightguide 806 as opposed to leaking out the sides. A convex curvature on the LED lens 804 would accomplish this reduction in dispersion. An LED lens 804 can be manufactured out of cast acrylic and can be sized to be attached to an IR LED 802 die as part of the IR LED 802 packaging. A convex curvature on the LED lens 804 would provide the increase in dispersion from a critical angle to a wide angle.

When the IR light is emitted from the IR lightguide 806 an optional output lens 808 can be located proximal to the IR lightguide 806 to expand the field of illumination of the IR lightguide 806 beyond the critical angle of the IR lightguide 806. A concave curvature on the output lens 808 can accomplish increasing the dispersion of the light emitted from the IR lightguide 806 from a critical angle to wide-field illumination. Output lens 808 can be manufactured from cast acrylic, including a Fresnel lens geometry, or can be manufactured using diffractive optics. Diffractive optics can reduce the size of output lens 808 and permit the IR lightguide 806 to be placed in closer proximity to the LCD front panel 602.

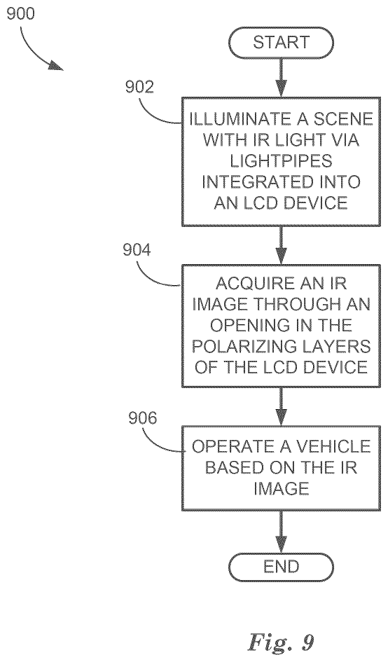

FIG. 9 is a flowchart diagram of a process 900 for operating a vehicle based on acquiring image data with a camera 626 included in a border 504 of a display device 118. Process 900 can be implemented as software executing on a computing device 115 and hardware including a display device 118 as described herein. Process 900 includes multiple blocks that can be executed in the illustrated order. Process 900 could alternatively or additionally include fewer blocks and can include the blocks executed in different orders.

Process 900 begins in block 902, where one or more IR LEDs 630, 632 located in a border 504 of a display device 118 emit wide-field illumination under control of computing device 115 to illuminate a portion of a vehicle interior that can include one or more occupants. IR LEDs 630, 632 illuminate a portion of a vehicle interior to permit computing device 115 to acquire image data of vehicle occupants via a camera 626, without disturbing vehicle occupants by employing frequencies of IR light that are not visible to humans to augment ambient light at night and other low-ambient light situations.

At block 904 computing device 115 acquires wide field of view image data from a camera 626 located in a border 504 of a display device 118 while the interior of the vehicle is illuminated by the IR LEDs 630, 632. The camera 626 can be an IR video camera, for example. The camera 626 can acquire the wide field of view image data via a lens 628, which can be a fisheye lens. Camera 626 can be used to acquire image data for biometric facial identification of occupants, verification that an occupant is attentive and poised to assume control of the vehicle during hands-free operation of the vehicle, and video telephony and video conferencing via cellular networks.

At block 906 computing device 115 uses image data acquired from the camera 626 to operate a vehicle 110. Computing device 115 can acquire an image of an occupant's face and perform biometric facial recognition as described in block 904 to determine whether the occupant is an authorized user of the vehicle 110. In another example, computing device 115 can acquire an image and verify that the occupant is attentive and poised to assume control as described in block 904 to permit hands-free operation of the vehicle 110. If the computing device 115 determines that the occupant is not poised to assume control of the vehicle 110, a warning message can be displayed on display device 118 and if the occupant does not return to attentive behavior, stop the vehicle. Image data acquired from camera 626 can be used to determine if an occupant is falling asleep when they should be paying attention and warn the occupant to wake up. If the occupant does not wake up computing device 115 can stop the vehicle 110. The computing device 115 can cause data can be displayed on LCD device 118 and acquire image data with camera 626 that includes a response to the displayed data. For example, the LCD device 118 can display a volume control for audio data being output by an audio system included in the vehicle 110. In response to the data displayed on the LCD device 118, an occupant can make an “up” or “down” gesture with their hand. Computing device can acquire image data with camera 626, process the image data to determine a direction of the occupant's gesture and turn the audio volume up or down in response to the determined gesture. Following block 906 process 900 ends.

Any action taken by a vehicle or user of the vehicle in response to one or more navigation prompts disclosed herein should comply with all rules and regulations specific to the location and operation of the vehicle (e.g., Federal, state, country, city, etc.). More so, any navigation prompts disclosed herein are for illustrative purposes only. Certain navigation prompts may be modified and omitted depending on the context, situation, and applicable rules and regulations. Further, regardless of the navigation prompts, users should use good judgement and common sense when operating the vehicle. That is, all navigation prompts, whether standard or “enhanced,” should be treated as suggestions and only followed when safe to do so and when in compliance with any rules and regulations specific to the location and operation of the vehicle.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and technologies, including, without limitation, and either alone or in combination, Java™, C, C++, Python, Julia, SCALA, Visual Basic, Java Script, Perl, HTML, etc. In general, a processor (i.e., a microprocessor) receives commands, (i.e., from a memory, a computer-readable medium, etc.), and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example (i.e., a candidate to an “exemplary widget” should be read as simply referring to an example of a widget).

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system comprising:
a computer including a processor and a memory storing instructions executable by the processor to:
acquire an image from a camera included in a light emitting diode (LED) backlit liquid crystal display (LCD) device, wherein the camera is located adjacent to an active display area of the LCD device through a portion of a front panel of the LCD device in which one or more polarizing layers of the front panel are absent to permit IR light to reach the camera; and
illuminate a scene beyond the front panel of the LCD device with IR light emitted by IR LEDs attached to a backlight substrate and directed to the front panel of the LCD device by IR lightguides.

2. The system of claim 1, wherein the camera is mounted on a substrate located behind the backlight substrate.

3. The system of claim 1, wherein the IR LEDs are mounted on the backlight substrate that includes LEDs.

4. The system of claim 1, wherein the IR lightguides connect the IR LEDs to the front panel of the LCD device.

5. The system of claim 1, wherein the front panel of the LCD device includes a glass cover, an LCD panel, and the one or more polarizer layers.

6. The system of claim 1, wherein the camera includes a wide-angle lens.

7. The system of claim 6, wherein the IR lightguides emit IR light which illuminate the scene included in a field of view of the camera with the wide-angle lens.

8. The system of claim 1, wherein the IR lightguides are arranged in a circle or a rectangle adjacent to the camera.

9. The system of claim 1, wherein the LCD device is included in a vehicle.

10. The system of claim 9, wherein the LCD device is included in a dashboard included in the vehicle.

11. The system of claim 9, wherein the vehicle is operated based on the image.

12. A method comprising:
acquiring an image from a camera included in a light emitting diode (LED) backlit liquid crystal display (LCD) device, wherein the camera is located adjacent to an active display area of the LCD device through a portion of a front panel of the LCD device in which one or more polarizing layers of the front panel are absent to permit IR light to reach the camera; and
illuminating a scene beyond the front panel of the LCD device with IR light emitted by IR LEDs attached to a backlight substrate and directed to the front panel of the LCD device by IR lightguides.

13. The method of claim 12, wherein the camera is mounted on a substrate located behind the backlight substrate.

14. The method of claim 12, wherein the IR LEDs are mounted on the backlight substrate that includes LEDs.

15. The method of claim 12, wherein the IR lightguides connect the IR LEDs to the front panel of the LCD device.

16. The method of claim 12, wherein the front panel of the LCD device includes a glass cover, an LCD panel, and the one or more polarizer layers.

17. The method of claim 12, wherein the camera includes a wide-angle lens.

18. The method of claim 17, wherein the IR lightguides emit IR light which illuminate the scene included in a field of view of the camera with the wide-angle lens.

19. The method of claim 12, wherein the IR lightguides are arranged in a circle or a rectangle adjacent to the camera.

20. The method of claim 12, wherein the LCD device is included in a vehicle.
